(19) United States
(12) Patent Application Publication
(10) Pub. No.: US 2025/0012470 A1
(43) Pub. Date: Jan. 9, 2025

(54) METHOD FOR CONTROLLING AIR HANDLING UNIT

(71) Applicant: Kojimachi Engineering Co., Ltd., Tokyo (JP)

(72) Inventors: Michio KAGITANI, Kanagawa (JP); Isao OKAYASU, Kanagawa (JP); Munemasa KOBAYASHI, Kanagawa (JP)

(21) Appl. No.: 18/577,321

(22) PCT Filed: Mar. 15, 2022
(86) PCT No.: PCT/JP2022/011526

§ 371 Date: Sep. 12, 2024

(30) Foreign Application Priority Data
Jul. 12, 2021 (JP) 2021-114920

(51) Int. Cl. F24F 11/49; F24F 110/10; F24F 140/50

(52) U.S. Cl. CPC F24F 11/49; F24F 2110/10; F24F 2140/50

(57) ABSTRACT

To provide a method for controlling an air handling unit by correcting a designed supply air temperature using a simple method in consideration of a heat load.

The method is a method for controlling an air handling unit by correcting a designed supply air temperature T_{S} according to a heat load in a space before operation, and using a corrected supply air temperature T_{S}x during the operation, and includes calculating an indoor-load heat quantity Sc, reading an outside air-load specific enthalpy change amount Δi_{O} from a psychrometric chart and converting the outside air-load specific enthalpy change amount Δi_{O} into an outside air-load heat quantity Od, summing the indoor-load heat quantity Sc and the outside air-load heat quantity Od to calculate a space-load heat quantity Pc and converting the space-load heat quantity Pc into a space-load specific enthalpy change amount Δi_{L}x, applying the space-load specific enthalpy change amount Δi_{L}x to the psychrometric chart to read a specific enthalpy value i_{S}x of corrected supply air SAx and determining a corrected supply air temperature T_{S}x associated with the specific enthalpy value i_{S}x, and controlling the air handling unit by using the corrected supply air temperature T_{S}x after a start of the operation.

### FIELD

The present invention relates to a method for controlling an air handling unit that air-conditions a space including a perimeter zone.

### BACKGROUND

A central air-conditioning system that is air-conditioning equipment for medium-scale and large-scale buildings uses an air handling unit that is a type of air conditioner (hereinafter, sometimes abbreviated as “AHU”). A wide floor is generally divided into a perimeter zone that is a window-side zone easily affected by outside air and an interior zone hardly affected by the outside air. The floor may be divided into a plurality of spaces that may be air-conditioned respectively by a plurality of AHUs. In that case, a uniform supply air temperature is set for the AHUs based on a maximum heat load on the floor. Each of the AHUs is operated with the set supply air temperature usually maintained at a constant temperature throughout the entire summer or winter (for example, Patent Literature 1).

Patent Literature 1 proposes a configuration of a control device in an air handling unit in order to solve a problem that wasteful energy consumption increases when an AHU is operated with its supply air temperature maintained at a constant set value. The control device is configured to detect a supply air temperature and a return air temperature, calculate set values of a supply-air delivery volume and the supply air temperature, and transmit a signal indicating the set values to a supply-air temperature setting unit.

### CITATION LIST

### Patent Literatures

Patent Literature 1: Japanese Patent Application Laid-open No. H03-168558
Patent Literature 2: Japanese Patent Application Laid-open No. H04-283343

### SUMMARY

### Technical Problem

Since the control device in the AHU in Patent Literature 1 executes real-time control, the AHU requires a control device provided with an advanced control program and in addition, this control device cannot be applied as it is to an existing AHU.

In a case where a floor is divided into a plurality of spaces, each of which is air-conditioned by each individual AHU, even though a heat load differs depending on the direction toward which each of the spaces faces or depending on the time zone, conventionally a uniform supply air temperature that is set based on a maximum heat load on the floor is applied to all the spaces to control the individual AHUs. This also leads to wasteful consumption of cold and hot water.

Considering the circumstances described above, it is an object of the present invention to provide a method for controlling a plurality of air handling units that air-condition a plurality of spaces on a floor, in which a designed supply air temperature common to the spaces is corrected by a simple method in consideration of a heat load in each of the spaces, and the corrected supply air temperature is used to control each of the air handling units.

### Solution to Problem

In order to achieve the above object, the present invention provides the following configurations. Numerals in parentheses are reference signs in the drawings described later and denoted for reference.

An aspect of the present invention provides a method for controlling an air handling unit in which a plurality of spaces on a floor are air-conditioned respectively by a plurality of air handling units, each of the spaces including at least a perimeter zone,
a cooling capacity (H) and an air delivery volume (Q) of each of the air handling units are set according to an area of each of the spaces based on common design parameters including an outside-air volume ratio, an outside air temperature (T_{O}) and a relative humidity thereof, a supply air temperature (T_{S}) and a relative humidity thereof, and a return air temperature (T_{R}) and a relative humidity thereof, and
the supply air temperature (T_{S}) designed is corrected according to a heat load in each of the spaces before operation to control each of the air handling units by using a corrected supply air temperature (T_{S}x) during operation, the method comprising:
(a) a step of calculating an indoor-load heat quantity (Sc) in each of the spaces, the indoor-load heat quantity (Sc) including at least a quantity of heat entry or a quantity of heat loss in the perimeter zone;
(b) a step of reading a designed outside air-load specific enthalpy change amount (Δi_{O}) from a psychrometric chart created based on the design parameters, and converting the outside air-load specific enthalpy change amount (Δi_{O}) into a designed outside air-load heat quantity (Od);
(c) a step of summing the indoor-load heat quantity (Sc) and the outside air-load heat quantity (Od) to calculate a space-load heat quantity (Pc), and converting the space-load heat quantity (Pc) calculated into a space-load specific enthalpy change amount (Δi_{L}x);
(d) a step of applying the space-load specific enthalpy change amount (Δi_{L}x) to the psychrometric chart to read a specific enthalpy value (i_{S}x) of corrected supply air (SAx), and determining a corrected supply air temperature (T_{S}x) associated with the specific enthalpy value (i_{S}x) in each of the spaces from the psychrometric chart; and
(e) a step of controlling each of the air handling units by using the corrected supply air temperature (T_{S}x) after a start of operation.

The method can also comprise: in place of the steps (b) and (c),
(b′) a step of converting the indoor-load heat quantity (Sc) into an indoor-load specific enthalpy change amount (Δi_{R}x); and
(c′) a step of reading a designed outside air-load specific enthalpy change amount (Δi_{O}) from a psychrometric chart created based on the design parameters, and summing the outside air-load specific enthalpy change amount (Δi_{O}) and the indoor-load specific enthalpy change amount (Δi_{R}x) to calculate a space-load specific enthalpy change amount (Δi_{L}x).

It is preferred that the step (a) according to the aspect includes calculating the indoor-load heat quantity (Sc) for each time zone and calculating the space-load heat quantity (Pc) for each time zone, thereby to determine the corrected supply air temperature (T_{S}x) for each time zone.

It is preferred that the step (a) according to the aspect includes calculating the indoor-load heat quantity (Sc) for both a fine weather and a cloudy weather, and calculating the space-load heat quantity (Pc) for both a fine weather and a cloudy weather, thereby to determine the corrected supply air temperature (T_{S}x) for both a fine weather and a cloudy weather.

### Advantageous Effects of Invention

According to the present invention, in consideration of the heat load in the space to be air-conditioned by each of the air handling units for which designed supply air temperatures are set, each of the designed supply air temperatures is corrected before operation, and each of the air handling units is controlled by using the corrected supply air temperature. As a result, it is possible to reduce heat consumption energy of cold or hot water supplied to the air handling units. The method for controlling a plurality of air handling units according to the present invention is a simple method to control the air handling units by correcting the supply air temperature from a design specification value to a proper value before operation, and setting the corrected value during operation. Accordingly, it is unnecessary to execute control to change the setting of the supply air temperature in real time based on real-time temperature detection. Therefore, this method can be implemented at low cost and is easily applicable to existing air handling units.

### BRIEF DESCRIPTION OF DRAWINGS

FIG. 1 is a diagram schematically illustrating an example of an overall configuration of an air-conditioning system including AHUs.

FIG. 2 is a cross-sectional view schematically illustrating a configuration of the AHU.

FIG. 3A is a schematic flowchart illustrating an example of a method for controlling an AHU according to the present invention.

FIG. 3B is a schematic flowchart illustrating another example in which the flowchart of FIG. 3A is partially changed.

FIG. 4 is a psychrometric chart in summer (August) created based on examples of design parameters.

Table 1 in FIG. 5 shows a status of designed heat loads for a fine weather in the space oriented to the south direction during cooling (August), Table 2 shows a status of calculated heat loads, and Table 3 shows energy saving effects.

Table 4 in FIG. 6 shows a status of calculated heat loads and Table 5 shows energy saving effects.

FIG. 7 is a psychrometric chart in winter (January) created based on examples of design parameters.

Table 6 in FIG. 8 shows a status of designed heat loads for a fine weather/a cloudy weather in the space oriented to the south direction during heating (January), Table 7 shows a status of calculated heat loads, and Table 8 shows energy saving effects.

### DESCRIPTION OF EMBODIMENTS

Embodiments of the present invention will be described below in detail with reference to the drawings.

### (1) Overall Configuration of Air-Conditioning System

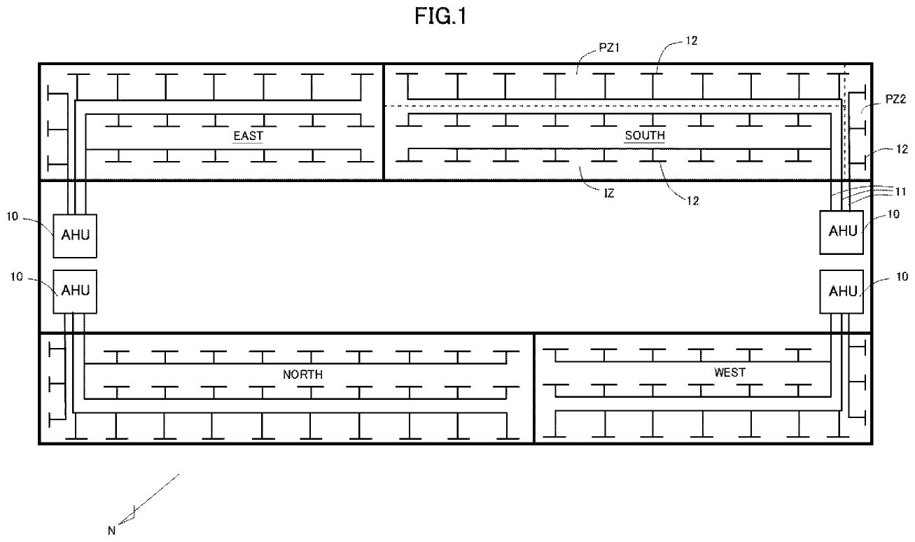

FIG. 1 is a diagram schematically illustrating an example of an overall configuration of an air-conditioning system to which the present invention is applied. One floor of a building illustrated in FIG. 1 in plan view is substantially rectangular. On this floor, there are four corner spaces, each of which includes an interior zone and a perimeter zone. The four corner spaces are oriented substantially to the east, west, south, and north directions, respectively. In the present invention, each of the spaces includes at least the perimeter zone. The spaces are air-conditioned respectively by four air handling units (AHUs) 10 installed in a machine room or the like. The number of plural spaces is not limited to four. The number of plural AHUs, each of which air-conditions each of the spaces, is not limited to four.

The space oriented to the south is described as an example. This space includes one interior zone IZ, a first perimeter zone PZ1 facing the south east, and a second perimeter zone PZ2 facing the south west. Three ducts 11 connected to one AHU 10 extend to the zones IZ, PZ1, and PZ2. Supply air is delivered from a plurality of outlets 12 through the three ducts 11. Return air that is indoor air also returns to the AHU 10 via a duct (not illustrated).

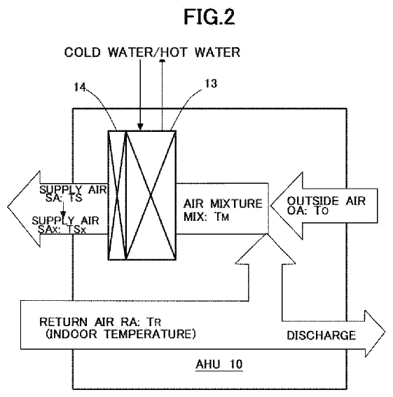

FIG. 2 schematically illustrates a general configuration of the AHU 10. The AHU 10 mixes intake outside air OA with a portion of return air RA from a room at a predetermined outside-air volume ratio to form an air mixture MIX, causes the air mixture MIX to exchange heat with cold water or hot water through a hot and cold water coil 13 to adjust the temperature of the air mixture MIX, and humidifies the air mixture MIX using a humidifier 14 as needed to supply the humidified air mixture MIX as supply air SA to each of the spaces. During operation, the AHU 10 detects a temperature of the supply air SA by using a temperature sensor (not illustrated), and controls the amount of cold water or hot water such that the supply air SA becomes its designed temperature T_{S}.

For the four AHUs 10 that respectively air-condition four spaces on the floor illustrated in FIG. 1, an air-conditioning capacity H (kcal/h) and an air delivery volume (m³/h) are set according to the area of each of the four spaces based on design parameters common to the four AHUs 10. The air-conditioning capacity H is a cooling capacity in summer, while being a heating capacity in winter.

In summer, the common design parameters include at least the following parameters.
Outside-air volume ratio (for example, 23.5%)
Temperature T_{O} of the outside air OA and its relative humidity (for example, 33.5° C. and 63%)
Temperature T_{R} of the return air RA and its relative humidity (for example, 25° C. and 50%)
Temperature T_{S} of the supply air SA and its relative humidity (for example, 12° C. and 95%)

In summer, the cooling capacity H (kcal/h) and the air delivery volume (m³/h) of each individual AHU 10 are set according to the area of each of the spaces based on the above common design parameters as follows as an example.
Space oriented to the south direction: cooling capacity 90000 kcal/h and air delivery volume 12500 m³/h
Space oriented to the west direction: cooling capacity 64080 kcal/h and air delivery volume 8900 m³/h
Space oriented to the north direction: cooling capacity 82800 kcal/h and air delivery volume 11500 m³/h
Space oriented to the east direction: cooling capacity 56800 kcal/h and air delivery volume 7900 m³/h

Perimeter zones are affected by outside air through window glass or walls (skin load). The skin load is the quantity of heat entry in summer, while being the quantity of heat loss in winter. Since the spaces are oriented to different directions, the skin load differs between the perimeter zones. Despite these differences, the supply air temperature T_{S} is still set at a uniform value, resulting in wasteful consumption of cold water in some of the orientation directions and some of the time zones. The present invention proposes a method for controlling each of the AHUs 10 by correcting the supply air temperature T_{S} according to the heat load in each of the spaces, and using a corrected supply air temperature T_{S}x.

The correction of the supply air temperature T_{S} is performed in advance before operation of the AHU 10. After the corrected supply air temperature T_{S}x is set, operation of the AHU 10 is started. The settings remain fixed during the operation. For example, even in a case where a set value is varied in each time zone, the set value in each time zone is preset with a timer before daily operation, and remains fixed during the operation. That is, the method for controlling an air handling unit according to the present invention is not real-time processing, but is so-called batch processing. Therefore, although it is not possible to perform real-time optimization processing, it is still possible to reliably achieve significant energy savings over a long span such as on a monthly or seasonal basis. Since this method is easily applicable particularly to the existing air-conditioning systems, significant energy saving effects can be obtained at low cost.

### (2) Method for Controlling Air Handling Unit

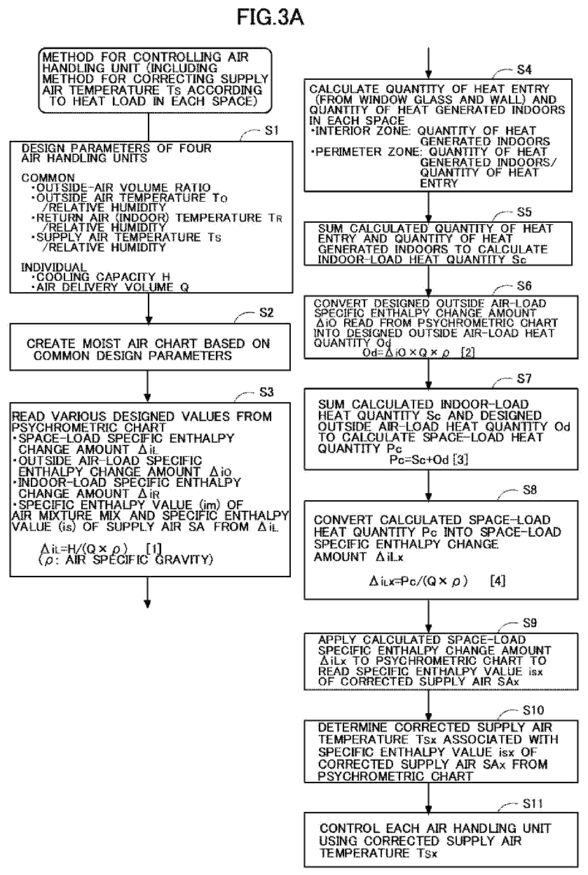

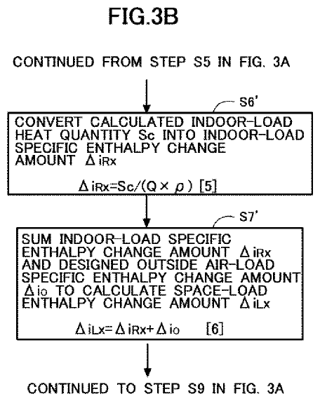

FIG. 3A is a schematic flowchart illustrating an example of the method for controlling an air handling unit according to the present invention. While basically the same flow is used in both summer and winter, FIG. 3A illustrates the flow for summer as an example.

It is shown in Step 1 that, as described above, common design parameters are set for four AHUs that respectively air-condition four spaces, and based on the common design parameters, the cooling capacity H and the air delivery volume Q are set according to the area of each of the spaces.

In Step 2, based on the design parameters in Step 1, a moist air chart (hereinafter, referred to as “psychrometric chart”) is created. In the existing air-conditioning systems, the psychrometric chart having already been created may be used if available, or a psychrometric chart may be additionally created based on the design parameters.

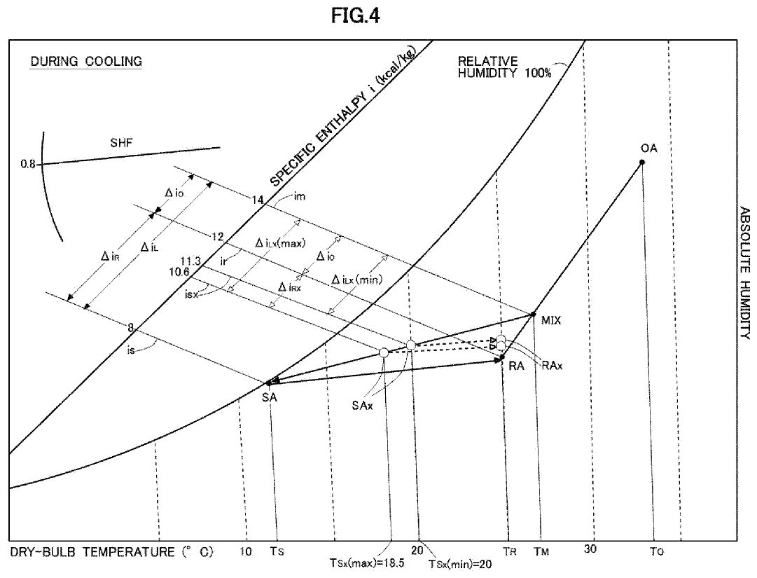

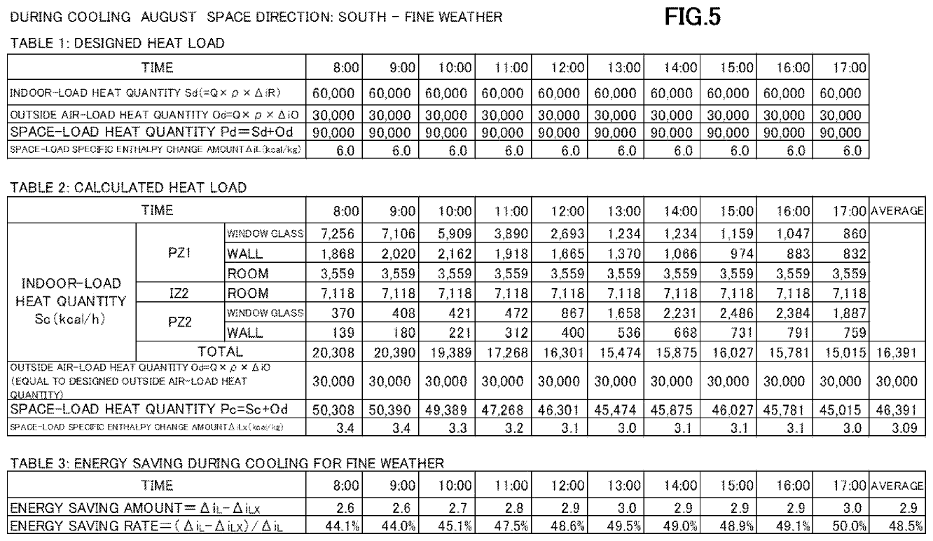

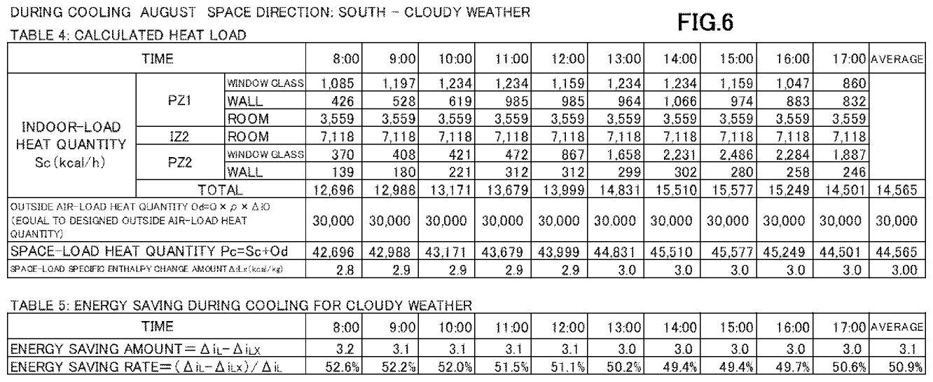

FIG. 4 is a psychrometric chart during cooling in summer (August) created based on the above examples of the design parameters. The air condition based on the design parameters changes in the following manner. The air mixture MIX (temperature T_{M}=27° C.) is determined by the outside-air volume ratio that is a ratio of mixture between the outside air OA (temperature T_{O}=33.5° C.) and the return air RA (temperature (indoor temperature) T_{R}=25° C.). This air mixture MIX is cooled to the temperature of the supply air SA (temperature T_{S}=12° C.) with a cold water coil, and delivered to the room. The temperature of the delivered air increases in the room and the delivered air becomes the return air RA. The line connecting the supply air SA and the return air RA is parallel to the line showing a sensible heat factor SHF (0.8 in the psychrometric chart).

In Step 3, various designed values can be read from the psychrometric chart created based on the design parameters. For example, a specific enthalpy change amount Δi_{L} from the air mixture MIX to the supply air SA is a difference “6” between a specific enthalpy value “im” (=14) of the air mixture MIX and a specific enthalpy value “is” (=8) of the supply air SA. Δi_{L} is referred to as “space-load specific enthalpy change amount”.

Within the range of the space-load specific enthalpy change amount Δi_{L}, a difference “2” between the specific enthalpy value “im” (=14) of the air mixture MIX and a specific enthalpy value “ir” (=12) of the return air RA is a specific enthalpy change amount Δi_{O} associated with a load of the outside air OA drawn by the AHU. Δi_{O} is referred to as “outside air-load specific enthalpy change amount”.

A difference “4” between the specific enthalpy value “ir” (=12) of the return air RA and the specific enthalpy value “is” (=8) of the supply air SA is a specific enthalpy change amount Δi_{R} associated with a load in the space (a skin load and/or a quantity of heat generated indoors). Δi_{R} is referred to as “indoor-load specific enthalpy change amount”. Therefore, the space-load specific enthalpy change amount Δi_{L} is the sum of the outside air-load specific enthalpy change amount Δi_{O} and the indoor-load specific enthalpy change amount Δi_{R}.

The space-load specific enthalpy change amount Δi_{L} in the psychrometric chart in summer is associated with the designed heat quantity to be removed by cold water. The specific enthalpy change amount Δi_{L} and the designed cooling capacity H are correlated with each other by the following expression.

$$Δ {i}_{L} = H / ( Q \times ρ ) \qquad [ 1 ]$$

Δi_{L}: Designed space-load specific enthalpy change amount (kcal/kg)
H: Designed cooling capacity (kcal/h)
Q: Air delivery volume (m³/h)
p: Air specific gravity 1.2 kg/m³

Expression 1 can also be used as a conversion formula between a specific enthalpy change amount Δi other than a design value and its associated heat quantity (that is, a heat load). In that case, the air delivery volume Q and the air specific gravity p are supposed to be constant.

Table 1 in FIG. 5 shows a status of designed heat loads for a fine weather in the space oriented to the south direction during cooling (August). A designed indoor-load heat quantity Sd and a designed outside air-load heat quantity Od are calculated using Expression 1 (the specific formulas are described in Table 1, where the air delivery volume Q=12500 m³/h). A designed space-load heat quantity Pd is the sum of Sd and Od. Since Table 1 shows design values, each of the heat load-related quantities is a constant value.

When the designed supply air temperature T_{S} is changed by correction, the specific enthalpy value “is” (=8) of the supply air SA varies, and as a result, the space-load specific enthalpy change amount Δi_{L} varies significantly. Hereinafter, the specific enthalpy value of corrected supply air SAx is represented as “i_{S}x”, and the space-load specific enthalpy change amount obtained after the correction is represented as “Δi_{L}x”.

Next, a method for correcting the designed supply air temperature T_{S} is described more specifically.

Table 2 in FIG. 5 shows a status of actual heat loads calculated in each time zone for a fine weather in the space oriented to the south direction during cooling (August). In Step 4 in FIG. 3A, the quantity of heat entry and the quantity of heat generated indoors are calculated for each space, and the calculated quantity of heat entry and quantity of heat generated indoors are summed in Step 5 to calculate an indoor-load heat quantity Sc (kcal/h) in the space. In the space oriented to the south direction, the perimeter zone PZ1 illustrated in FIG. 1 has the quantity of heat entering from the window glass and the wall, and the quantity of heat generated indoors, while the interior zone IZ has only the quantity of heat generated indoors, and the perimeter zone PZ2 has only the quantity of heat entry. The existing air-conditioning systems use these quantities that they usually have already obtained. The quantity of heat entry is calculated from, for example, daylight heat and conductive heat through window glass and an outside wall. The quantity of heat generated indoors is calculated from sensible heat or latent heat of a human body or lighting. These calculation methods are commonly known.

In Step 6, the designed outside air-load specific enthalpy change amount Δi_{O} is read from the psychrometric chart to convert the read outside air-load specific enthalpy change amount Δi_{O} into the designed outside air-load heat quantity Od, using the above Expression 1 as expressed below.

$$Od = Δ {i}_{O} \times Q \times ρ \qquad [ 2 ]$$

In the present invention, a designed value is used as it is for the load of outside air to be drawn by an AHU.

In Step 7, the indoor-load heat quantity Sc calculated in Step 5, and the outside air-load heat quantity Od converted from the outside air-load specific enthalpy change amount Δi_{O} in Step 6 are summed as expressed below to calculate a space-load heat quantity Pc in the space.

$$Pc = Sc + Od \qquad [ 3 ]$$

In Step 8, the space-load heat quantity Pc calculated in Step 7 is converted into a specific enthalpy change amount, using the above Expression 1 to obtain the space-load specific enthalpy change amount Δi_{L}x.

$$Δ {i}_{L} x = Pc / ( Q \times ρ ) \qquad [ 4 ]$$

In Step 9, the space-load specific enthalpy change amount Δi_{L}x obtained in Step 8 is applied to the psychrometric chart illustrated in FIG. 4. That is, the space-load specific enthalpy change amount Δi_{L}x is applied as an amount of change in the specific enthalpy in a decreasing direction from the specific enthalpy value “im” of the air mixture MIX. In Table 2 in FIG. 5, a maximum value Δi_{L}x (max) of Δi_{L}x for a fine weather is 3.4. When this maximum value is applied to the psychrometric chart of FIG. 4, the value “10.6” is read as a specific enthalpy value “i_{S}x” of the corrected supply air SAx.

In Step 10, based on the specific enthalpy value “i_{S}x” of the corrected supply air SAx read in Step 9, the corrected supply air temperature T_{S}x associated with this specific enthalpy value “i_{S}x” is determined from the psychrometric chart. In this example, the corrected supply air temperature T_{S}x is determined to be 18.5° C. from the psychrometric chart of FIG. 4. This value is equivalent to the maximum value Δi_{L}x (max) of Δi_{L}x for a fine weather. In contrast, a minimum value Δi_{L}x (min) of Δi_{L}x for a cloudy weather is 2.8 as shown in Table 4 of FIG. 6. When this minimum value is applied to the psychrometric chart of FIG. 4, the value “11.3” is read as the specific enthalpy value “i_{S}x” of the corrected supply air SAx, and the corrected supply air temperature T_{S}x associated with the value “11.3” is determined to be 20° C. from the psychrometric chart.

Therefore, the supply air temperature of an AHU that cools the space oriented to the south direction in summer (August) is changed from the design temperature T_{S} at 12° C. to the corrected temperature T_{S}x at 18.5° C. to 20° C., and then the AHU is operated with this corrected temperature T_{S}x, and can thus obtain energy saving effects by approximately 50% as shown in Table 3 in FIG. 5 and Table 5 in FIG. 6.

In FIG. 5 (for a fine weather) and FIG. 6 (for a cloudy weather), Δi_{L}X is calculated on an hourly basis to determine the corrected supply air temperature T_{S}x on an hourly basis. In a case where the corrected supply air temperature T_{S}x does not fluctuate significantly by time zone, the actual corrected supply air temperature T_{S}x to be set is fixed in all time zones, and only two different values may be employed, one for a fine weather and one for a cloudy weather (for example, a maximum value, an average value, or the like). Alternatively, an equal value may be employed for both a fine weather and a cloudy weather. Alternatively, two different values may be employed, one for the morning and one for the afternoon. In this example, Table 2 in FIG. 5 and Table 4 in FIG. 6 show an example of the space load in August. However, the corrected supply air temperature T_{S}x of an AHU in each space may be varied on a monthly basis, a semimonthly basis, or a weekly basis. Alternatively, one corrected supply air temperature T_{S}x may be used throughout summer. These steps of correcting the supply air temperature T_{S} and determining the actual corrected supply air temperature T_{S}x are performed before operation of the AHU.

In Step 11, the AHU is operated. In that case, the corrected supply air temperature T_{S}x determined in the step described above is set for the AHU as a set value, and the supply air temperature is controlled so as to become the set corrected supply air temperature T_{S}x.

Although not specifically described in this example, since the status of heat loads differs in other spaces oriented to different directions, the corrected supply air temperature T_{S}x appropriate to each of the spaces is determined. With the appropriate corrected supply air temperature T_{S}x, each of the spaces is properly air-conditioned.

FIG. 3B is referenced here. FIG. 3B is a schematic flowchart illustrating another example in which the flowchart of FIG. 3A is partially changed. In the example in FIG. 3B, a different calculation process is performed to derive the space-load enthalpy change amount Δi_{L}x, using the indoor-load heat quantity Sc calculated in Step 5 in FIG. 3A. FIG. 3B illustrates only steps different from those in FIG. 3A.

In Step 6′ in FIG. 3B, the indoor-load heat quantity Sc calculated in Step 5 is converted into a specific enthalpy change amount, using the above Expression 1 to obtain an indoor-load specific enthalpy change amount Δi_{R}x.

$$Δ {i}_{R} x = Sc / ( Q \times ρ ) \qquad [ 5 ]$$

The indoor-load specific enthalpy change amount Δi_{R}x is equivalent to the amount of change between the specific enthalpy values “ir” and ““i_{S}x” as illustrated in the psychrometric chart of FIG. 4.

In Step 7′ in FIG. 3B, the indoor-load specific enthalpy change amount Δi_{R}x obtained in Step 6′, and the designed outside air-load specific enthalpy change amount Δi_{O} read from the psychrometric chart are summed to calculate the space-load enthalpy change amount Δi_{L}x.

$$Δ {i}_{L} x = Δ {i}_{R} x + Δ {i}_{O} \qquad [ 6 ]$$

The value of Δi_{L}x obtained in this step is equal to the value of Δi_{L}x obtained in Expression [4] in Step 8 in FIG. 3A. Thereafter, the same flow as illustrated in FIG. 3A is performed, including Step 9 and the steps subsequent to Step 9.

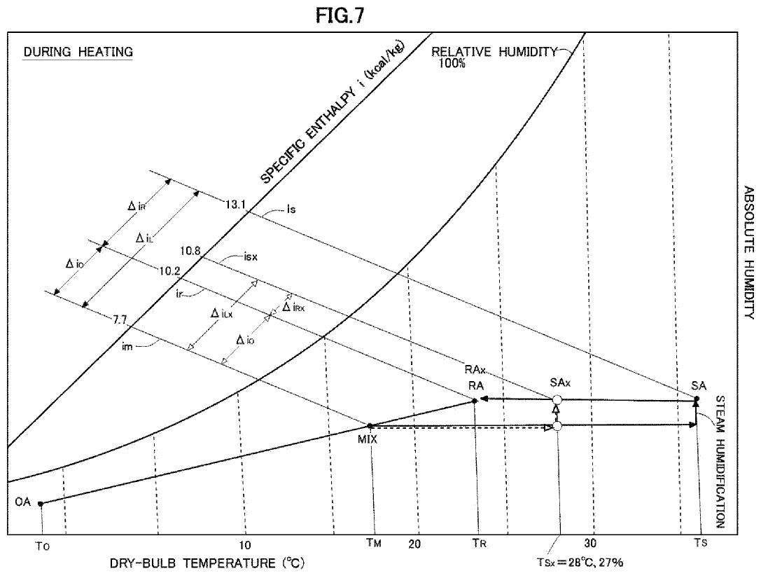

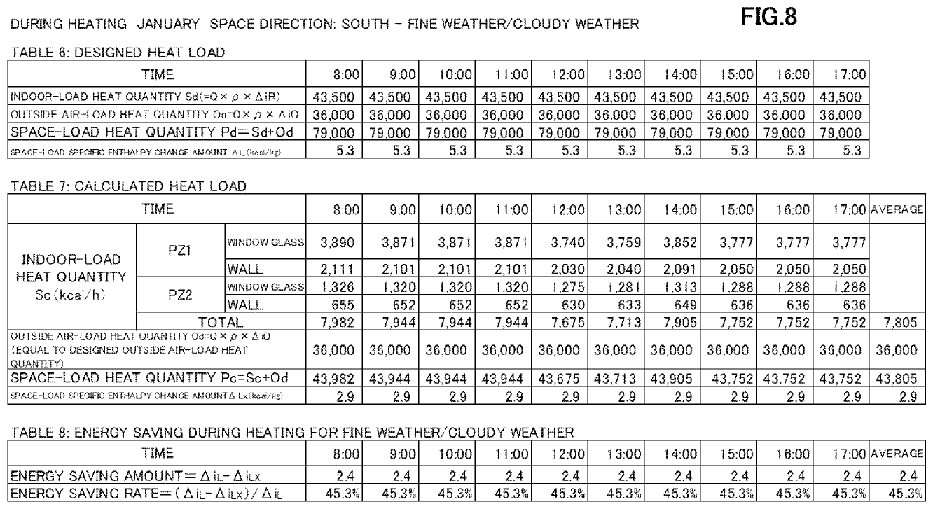

FIG. 7 is a psychrometric chart during heating in winter (January) created based on examples of design parameters for winter. The examples of design parameters common to each space in winter are as follows.
Outside-air volume ratio (for example, 23.5%)
Temperature T_{O} of the outside air OA and its relative humidity (for example, −2° C. and 50%)
Temperature T_{R} of the return air RA and its relative humidity (for example, 23.5° C. and 40%)
Temperature T_{S} of the supply air SA and its relative humidity (for example, 36° C. and 19%)

In winter, the heating capacity H (kcal/h) and the air delivery volume (m³/h) of each individual AHU 10 are set according to the area of each of the spaces based on the above common design parameters as follows as an example.
Space oriented to the south direction: heating capacity 117100 kcal/h and air delivery volume 12500 m³/h
Space oriented to the west direction: heating capacity 83300 kcal/h and air delivery volume 8900 m³/h
Space oriented to the north direction: heating capacity 107700 kcal/h and air delivery volume 11500 m³/h
Space oriented to the east direction: heating capacity 74000 kcal/h and air delivery volume 7900 m³/h

The air condition based on the design parameters in the psychrometric chart of FIG. 7 changes in the following manner. The air mixture MIX (temperature T_{M}=17.5° C.) is determined by the outside-air volume ratio that is a ratio of mixture between the outside air OA (temperature T_{O}=−2° C.) and the return air (indoor air) RA (temperature T_{R}=23.5° C.). This air mixture MIX is heated to the supply air temperature T_{S} (=36° C.) with a hot water coil, and further humidified (humidified with steam in this example) to deliver the supply air SA to the room. The temperature of the delivered air decreases in the room and the delivered air becomes the return air RA.

Table 7 in FIG. 8 shows a status of designed heat loads for a fine weather/a cloudy weather in the space oriented to the south direction during heating (January). In this example, since there are only slight differences in heat load between both types of weather in winter, the status of heat loads is shown without distinction between both types of weather. The methods for calculating the designed indoor-load heat quantity Sd, the designed outside air-load heat quantity Od, and the designed space-load heat quantity Pd are the same as those shown in the above Table 1 for summer. Since Table 6 shows designed values, each of the heat load-related quantities is a constant value.

As for the above case of summer, the method for controlling an AHU is described with reference to the flowcharts in FIGS. 3A and 3B. Since the method for controlling an AHU in winter is basically the same as that in summer, only differences from summer are described below.

Table 7 in FIG. 8 shows a status of actual heat loads calculated in each time zone for a fine weather/a cloudy weather in the space oriented to the south direction during heating (January). In winter, a different calculation method is used to calculate the heat quantity in each space in Step 4 in FIG. 3A. Only the quantity of heat loss in a perimeter zone is calculated in winter, and the quantity of heat generated indoors is set at zero. The flow including Step 5 and the steps subsequent to Step 5 is the same as that in summer, and thus descriptions thereof are omitted.

As illustrated in the psychrometric chart of FIG. 7, the supply air temperature of an AHU that heats the space oriented to the south direction in winter (January) is changed from the designed supply air temperature T_{S} at 36° C. and humidity of 19% to the corrected supply air temperature T_{S}x at 28° C. and humidity of 27%, and then the AHU is operated with these corrected temperature T_{S}x and humidity, and can thus obtain energy saving effects by approximately 45% as shown in Table 8 in FIG. 8.

Respective embodiments illustrated and described here are only examples and the present invention is not limited thereto, and various modifications can be made thereto.

### REFERENCE SIGNS LIST

10 AHU
11 duct
12 outlet
13 hot and cold water coil
14 humidifier
OA outside air
RA return air
MIX air mixture
SA supply air
SAx corrected supply air
RAx corrected return air
T_{O} outside air temperature
T_{R} return air temperature
T_{M} air mixture temperature
T_{S} supply air temperature
T_{S}x corrected supply air temperature
Δi_{L} space-load specific enthalpy change amount
Δi_{R} indoor-load specific enthalpy change amount
Δi_{O} outside air-load specific enthalpy change amount
Δi_{L}X space-load specific enthalpy change amount after correction
Δi_{R}x indoor-load specific enthalpy change amount after correction
im specific enthalpy value of air mixture
ir specific enthalpy value of return air
is specific enthalpy value of supply air
i_{S}x specific enthalpy value of corrected supply air

1. A method for controlling an air handling unit in which a plurality of spaces on a floor are air-conditioned respectively by a plurality of air handling units, each of the spaces including at least a perimeter zone,
a cooling capacity (H) and an air delivery volume (Q) of each of the air handling units are set according to an area of each of the spaces based on common design parameters including an outside-air volume ratio, an outside air temperature (T_{O}) and a relative humidity thereof, a supply air temperature (T_{S}) and a relative humidity thereof, and a return air temperature (T_{R}) and a relative humidity thereof, and
the supply air temperature (T_{S}) designed is corrected according to a heat load in each of the spaces before operation to control each of the air handling units by using a corrected supply air temperature (T_{S}x) during operation, the method comprising:
(a) a step of calculating an indoor-load heat quantity (Sc) in each of the spaces, the indoor-load heat quantity (Sc) including at least a quantity of heat entry or a quantity of heat loss in the perimeter zone;
(b) a step of reading a designed outside air-load specific enthalpy change amount (Δi_{O}) from a psychrometric chart created based on the design parameters, and converting the outside air-load specific enthalpy change amount (Δi_{O}) into a designed outside air-load heat quantity (Od);
(c) a step of summing the indoor-load heat quantity (Sc) and the outside air-load heat quantity (Od) to calculate a space-load heat quantity (Pc), and converting the space-load heat quantity (Pc) calculated into a space-load specific enthalpy change amount (Δi_{L}x);
(d) a step of applying the space-load specific enthalpy change amount (Δi_{L}X) to the psychrometric chart to read a specific enthalpy value (i_{S}x) of corrected supply air (SAx), and determining a corrected supply air temperature (T_{S}x) associated with the specific enthalpy value (i_{S}x) in each of the spaces from the psychrometric chart; and
(e) a step of controlling each of the air handling units by using the corrected supply air temperature (T_{S}x) after a start of operation.

2. The method for controlling an air handling unit according to claim 1, comprising:
in place of the steps (b) and (c),
(b′) a step of converting the indoor-load heat quantity (Sc) into an indoor-load specific enthalpy change amount (Δi_{R}x); and
(c′) a step of reading a designed outside air-load specific enthalpy change amount (Δi_{O}) from a psychrometric chart created based on the design parameters, and summing the outside air-load specific enthalpy change amount (Δi_{O}) and the indoor-load specific enthalpy change amount (Δi_{R}x) to calculate a space-load specific enthalpy change amount (Δi_{L}X).

3. The method for controlling an air handling unit according to claim 1 or 2, wherein the step (a) includes calculating the indoor-load heat quantity (Sc) for each time zone and calculating the space-load heat quantity (Pc) for each time zone, thereby to determine the corrected supply air temperature (T_{S}x) for each time zone.

4. The method for controlling an air handling unit according to any one of claims 1 to 3, wherein the step (a) includes calculating the indoor-load heat quantity (Sc) for both a fine weather and a cloudy weather, and calculating the space-load heat quantity (Pc) for both a fine weather and a cloudy weather, thereby to determine the corrected supply air temperature (T_{S}x) for both a fine weather and a cloudy weather.
